(19) United States
(12) Patent Application Publication
(10) Pub. No.: US 2025/0007774 A1
(43) Pub. Date: Jan. 2, 2025

(54) INFORMATION PROVISION SYSTEM AND CONTROL METHOD THEREFOR

(71) Applicant: CANON KABUSHIKI KAISHA, Tokyo (JP)

(72) Inventor: DAISUKE YAMAZAKI, Kanagawa (JP)

(21) Appl. No.: 18/755,159

(22) Filed: Jun. 26, 2024

(30) Foreign Application Priority Data
Jun. 29, 2023 (JP) 2023-107293

(51) Int. Cl. H04L 41/0681; H04L 41/0631; H04L 41/069

(52) U.S. Cl. CPC H04L 41/0681; H04L 41/0631; H04L 41/069

(57) ABSTRACT

An information provision system that provides information of an action recommended to resolve an error occurring in a network device, the information provision system includes a memory storing instructions, and a processor executing the instructions causing the information provision system to estimate an action to be executed for the error occurring in the network device, to determine whether the estimated action to be executed for the error occurring in the network device is a remotely executable action that is able to be performed by remotely transmitting a command to a target network device via a network, and to provide data for outputting information of candidates estimated as the action to be executed for the error occurring in the network device. When the remotely executable action is included in the candidates, data for outputting information indicating that a remote job is recommended is included in the provided data.

### BACKGROUND

### Field

The present disclosure relates to an information provision system and a control method thereof.

### Description of the Related Art

In the related art, a device management system for managing information and states of devices such as printers (hereinafter referred to as “devices”) has been constructed. When an error occurs in a device, the device notifies a device management system of error information. The device management system can manage an occurrence situation of the error by receiving the error information from the device. For example, an information provision system that provides error information to a technician taking charge of maintenance of devices using information collected from the devices is known. When a maintenance technician of a manufacturer visits a customer, it is possible to shorten the time period for resolving the error if the error information is known in advance. However, when it is difficult or time-consuming to physically visit a customer because the customer is geographically separated or the like, taking measures for a customer is delayed. Japanese Patent Laid-Open No. 2005-202886 discloses a maintenance support system that supports self-provisioning by acquiring information of a maintenance process on the same error in the past and remotely displaying the maintenance process on a computer screen of the customer when the error has occurred in a device.

However, since Japanese Patent Laid-Open No. 2005-202886 discloses support of a customer for resolving an error by himself or herself and the customer needs to handle the error, a handleable range is restrictive and depends on a skill level of the customer. When the error cannot be resolved by the customer, a technician will need to provide on-site support. On the other hand, when a device is connected to a network, an error may be resolved through a remote operation by a remote technician depending on details of an action. When an error can be resolved through a remote operation, a technician does not need to visit the customer and an error occurring at the customer can be rapidly resolved.

### SUMMARY

The present disclosure provides data for enabling recognition of an action to be recommended for remote execution.

An information provision system according to the present disclosure is an information provision system that provides information of an action recommended to resolve an error occurring in a network device, the information provision system includes a memory storing instructions, and a processor executing the instructions causing the information provision system to estimate an action to be executed for the error occurring in the network device, to determine whether the estimated action to be executed for the error occurring in the network device is a remotely executable action that is able to be performed by remotely transmitting a command to a target network device via a network, and to provide data for outputting information of candidates estimated as the action to be executed for the error occurring in the network device, wherein, when the remotely executable action is included in the candidates, data for outputting information indicating that a remote job is recommended is included in the provided data.

Further features of the present disclosure will become apparent from the following description of exemplary embodiments with reference to the attached drawings.

### BRIEF DESCRIPTION OF THE DRAWINGS

FIG. 1 is a diagram illustrating a configuration of an information provision system.

FIGS. 2A and 2B are diagrams illustrating a hardware configuration of the information provision system.

FIG. 3 is a diagram illustrating a software configuration of the information provision system.

FIG. 4 is a flowchart illustrating an action estimating process.

FIG. 5 is a flowchart illustrating a remote execution determining process according to a first embodiment.

FIG. 6 is a diagram illustrating an example of a repairing sequence display screen.

FIG. 7 is a diagram illustrating an example of the repairing sequence display screen.

FIG. 8 is a diagram illustrating an example of the repairing sequence display screen.

FIG. 9 is a diagram illustrating an example of the repairing sequence display screen.

FIG. 10 is a diagram illustrating an example of the repairing sequence display screen.

FIG. 11 is a flowchart illustrating a remote execution determining process according to a second embodiment.

FIG. 12 is a diagram illustrating an example of a repairing sequence display screen according to the second embodiment.

FIG. 13 is a diagram illustrating an example of the repairing sequence display screen according to the second embodiment.

FIG. 14 is a flowchart illustrating a remote execution determining process according to a third embodiment.

### DESCRIPTION OF THE EMBODIMENTS

### First Embodiment

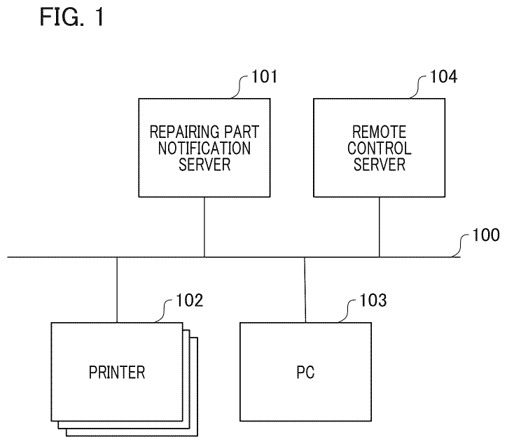

FIG. 1 is a diagram illustrating a configuration of an information provision system. The information provision system is a system that collects device operation information including error information or the like from a network device via a network and provides information of a repairing part or an action to be recommended. The information provision system includes a repairing part notification server 101, a printer 102 which is a network device, a personal computer (PC) 103, and a remote-control server 104. These are communicatively connected to each other via a network 100. The network 100 has only to be configured to transmit and receive data, and a communication system thereof is not particularly limited. For example, the network 100 is constituted by one of a LAN, a WAN, a cellular network such as LTE, or 5G, a wireless network, a telephone line, and a dedicated digital line or a combination thereof.

The repairing part notification server 101 provides data for outputting information of an action recommended to resolve an error occurring in a network device such as a printer 102 to a PC 103 used by an technician. The repairing part notification server 101 first receives error information indicating an error occurring in the printer 102 or the like from the network device and estimates information of one or more repairing parts for resolving the error. The repairing part notification server 101 manages results of actions executed for the same error in the past in the market as market results and determines a priority of an action on the basis of the market results. An action for an error is estimated on the basis of the market results in this embodiment, but the present disclosure is not limited thereto and an action for an error may be estimated, for example, using AI. The AI collects information of jobs performed by a service man or a replacement component, operates a trained model subjected to machine learning on the basis of the information, and estimates an action.

The printer 102 is an example of a network device that is managed by the information provision system. The printer 102 is, for example, an image forming device such as an MFP having a printing function, a FAX function, a copying function, and a scanner function. When occurrence of an error in the device is detected, the printer 102 transmits error information including device information to the repairing part notification server 101. In this embodiment, the network device is an image forming device, but the present disclosure is not limited thereto. For example, the network device may be an information processing device such as a 3D printer, a PC, or the like, an image processing device such as a camera, or a device such as smart appliances that can communicate, transit error information in a host device, and receive a remote operation.

The PC 103 is an example of an information processing device. A predetermined OS is installed in the PC 103. A predetermined OS is installed in the PC 103. A browser 331 which will be described later is installed in the PC 103. The PC 103 transmits a repairing component information acquisition request of the printer 102 to the repairing part notification server 101 via a browser 331, receives repairing component information as a response thereto from the repairing part notification server 101, and displays the received repairing component information using a GUI. Similarly, the PC 103 transmits a remote control information acquisition request to the remote control server 104 via the browser 331, receives remote control information as a response thereto from the remote control server 104, and displays the received remote control information using the GUI. That is, the PC 103 displays a screen that is provided by the information provision system via the browser 331 which is a web browser. The PC 103 is used, for example, by a company or the like that dispatches a technician (a service man) to which maintenance of the printer 102 is subcontracted. The technician can perform a remote control operation on the printer 102 via a screen that is provided by the remote control server 104 and that is displayed on the browser 331 of the PC 103. The PC 103 has only to be a terminal that can display a screen provided by the information provision system and may be a tablet, a smartphone, or the like.

The remote control server 104 receives a remote control operation for the printer 102 from the PC 103 and performs a remote control instruction for the printer 102 according to operation details. In the remote control, for example, an instruction to update software such as firmware or applications installed in the printer 102 and an instruction to change set values of software can be carried out. In this embodiment, the remote control server 104 and the repairing part notification server 101 are separated, but the repairing part notification server 101 may have the function of the remote control server 104 and be realized as the information provision system. The information provision system may be realized by a virtual machine (a cloud service) using resources provided from a data center including an information processing device in addition to one or more information processing devices or a combination thereof. The information provision system can also be realized as an application based on a web or can also be used using a web browser in the PC 103.

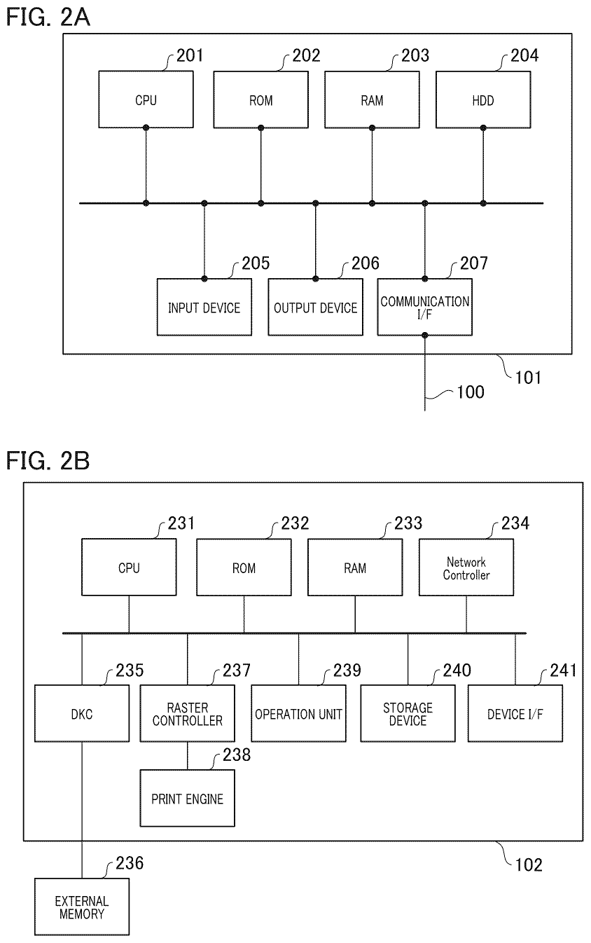

FIG. 2A is a diagram illustrating a hardware configuration of the repairing part notification server 101. The PC 103 and the remote control server 104 also have the same configuration. The repairing part notification server 101 includes a CPU 201, a ROM 202, a RAM 203, an HDD 204, an input device 205, an output device 206, and a communication I/F 207. The Central Processing Unit (CPU) 201 controls the repairing part notification server 101 as a whole. The CPU 201 reads a control program stored in the ROM 202 or the HDD 204 and performs various control processes.

The Read Only Memory (ROM) 202 is a memory dedicated for reading data and stores a basic control program of an information processing device such as a basic input/output system (BIOS). The Random Access Memory (RAM) 203 is a memory from/to which data can be read/written. The RAM 203 serves, for example, as a work area of the CPU 201. The Hard Disk Drive (HDD) 204 stores various types of data or programs. In this embodiment, the repairing part notification server 101 includes the HDD 204 as a storage device, but the present disclosure is not limited thereto, and the repairing part notification server 101 may include, for example, another storage device such as an SSD or a disk drive to which an external medium is loaded.

The input device 205 receives an operation from a user. For example, a keyboard and a pointing device are connected to the input device 205. The output device 206 performs display for a user. For example, a display such as a liquid crystal display is connected to the output device 206. The communication I/F 207 is an interface for connection to the network 100. The repairing part notification server 101 communicates with an external device such as the printer 102, the PC 103, or the remote control server 104 via the communication I/F 207 and the network 100.

After the repairing part notification server 101 has started, the BIOS is executed by the CPU 201 and an OS is executably loaded from the HDD 204 to the RAM 203. The CPU 201 executably loads various types of software modules which will be described later from the HDD 204 to the RAM 203 from time to time in response to operation of the OS. Various types of software modules are executed and operated by the CPU 201 in cooperation with the aforementioned devices. The communication I/F 207 is connected to the network 100 and controlled by the CPU 201 in response to operation of the OS to realize communication.

FIG. 2B is a diagram illustrating a hardware configuration of the printer 102. The printer 102 includes a CPU 231, a ROM 232, a RAM 233, a network controller 234, a DKC 235, a raster controller 237, a print engine 238, an operation unit 239, a storage device 240, and a device I/F. Among these, parts except the print engine 238 may be referred to as a controller taking charge of a control system of the printer. The constituents of the hardware are connected to a system bus.

The CPU 231 controls the printer 102 as a whole and comprehensively controls access to various devices connected to the system bus. The CPU 231 reads control programs stored in the ROM 232 or control programs or resource data (resource information) stored in an external memory 236 connected thereto via a disk controller (DKC 235) and performs various types of control processes.

The ROM 232 stores programs that are executed by the CPU 231. The RAM 233 serves as a main memory, a work area, or the like of the CPU 231. The RAM 233 is configured to extend a memory capacity thereof using an optional RAM connected to an extension port which is not illustrated. The storage device 240 is a storage means that serves as a large-capacity memory. The storage device 240 stores image data, various programs, and various types of setting information.

The network controller 234 is a communication controller and is, for example, a network interface card (NIC). The CPU 231 performs exchange of data with an external device on the network 100 via the network controller 234. The DKC 235 controls access to a storage device such as the external memory 236. The external memory 236 stores programs or resource data.

The operation unit 239 displays a screen and receives an operation instruction from a user via the screen. The operation unit 239 is, for example, a touch panel. By correlating input coordinates and display coordinates on the touch panel, a GUI can be constituted as if a user can directly operate the screen displayed on the touch panel. In the operation unit 239, buttons for displaying settings such as an operation mode of the printer 102 or operation states of the printer 102 and performing an operation of designating content data to be printed may be arranged.

The raster controller 237 is, for example, a controller for converting print data written in the PDL language to image data. The print engine 238 forms an image on a recording medium (for example, a sheet of paper) on the basis of image data input from the raster controller 237 using an existing printing technique. Examples of a printing system that is performed by the print engine 238 include an electromagnetic photography system (a laser beam system), an ink jet system, and a sublimation (thermal transfer) system, and the printing system is not particularly limited. The device I/F 241 is a connection I/F to an external device which can be connected using a USB.

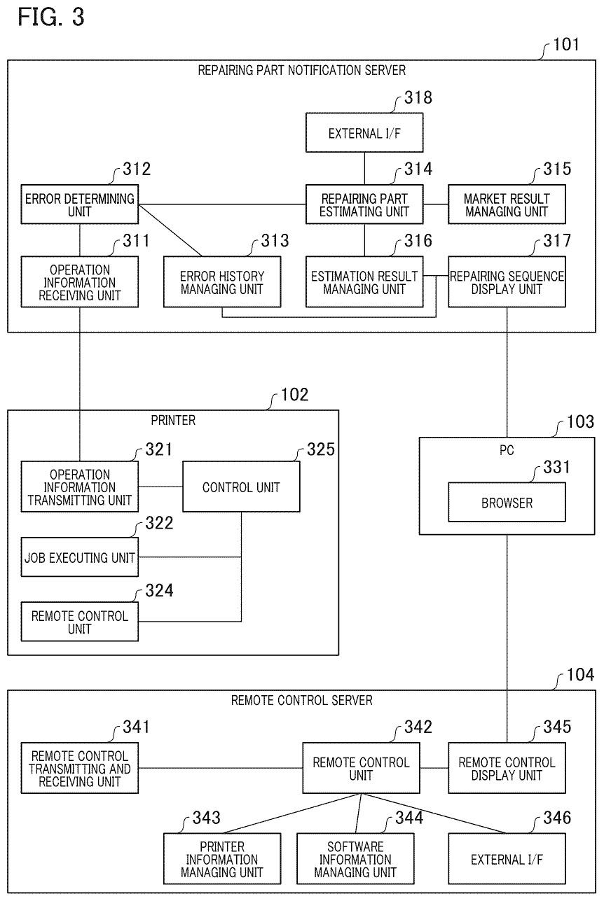

FIG. 3 is a diagram illustrating a software configuration of the information provision system. This software configuration is realized by causing a CPU to execute a program stored in a memory of each device. The repairing part notification server 101 includes an operation information receiving unit 311, an error determining unit 312, an error history managing unit 313, a repairing part estimating unit 314, a market result managing unit 315, an estimation result managing unit 316, a repairing sequence display unit 317, and an external I/F 318.

The operation information receiving unit 311 receives operation information from a printer 102. Operation information received by the operation information receiving unit 311 includes information for identifying a device, error information (event information) based on occurrence of an error, and information indicating an operating situation of the printer 102 such as the number of printed sheets and remaining amounts of consumables in the printer 102. The information for identifying a device included in the operation information includes, for example, a device ID for uniquely identifying the device and a model number indicating a model of the device. The error information is, for example, an error code for recognizing a type of an error. The error code is a unique character string code allocated to each type of an error. When the operation information includes error information, the operation information receiving unit 311 transmits the operation information to the error determining unit 312.

When the operation information including error information is received from the operation information receiving unit 311, the error determining unit 312 acquires an error history indicating error information having occurred in the past in the printer having transmitted the error information from the error history managing unit 313. The error determining unit 312 identifies one or more repairing components for resolving the error on the basis of the received error information. The error determining unit 312 handles the repairing component identified to resolve the error as a determination result of the error. The error determining unit 312 transmits the repairing component which is the determination result along with the operation information to the repairing part estimating unit 314. When no repairing component is identified such as when an error cannot be identified on the basis of the received error information (the error code), the error determining unit 312 sets the determination result to “no repairing component is identified.” The error determining unit 312 transmits the determination result “no repairing component is identified” along with the operation information to the repairing part estimating unit 314. The error determining unit 312 stores the operation information including the error information received from the printer 102 as an error history in the error history managing unit 313.

The error history managing unit 313 stores and manages operation information including error information received from the printer 102 as an error history. Table 1 is an example of the error history that is managed by the error history managing unit 313. Schemas or data of tables shown below are examples, and formats or the like of schemas or various types of data in the tables are not limited thereto.

TABLE 1

| | | Model | | Counter | |
|---|---|---|---|---|---|
| Error ID | Device ID | number | Error code | value | Occurrence date and time |
| Err-001 | DEV0000001 | Model-001 | E001-0001 | 5000 | 2022-10-01 T12:34:56Z |
| Err-002 | DEV0000002 | Model-002 | E002-0002 | 1500 | 2022-09-03 T00:00:00Z |
| Err-003 | DEV0000001 | Model-001 | E003-0001 | 2000 | 2022-09-01 T00:12:34Z |

The error history includes an error ID for uniquely identifying an error, a device ID for uniquely identifying a printer in which the error has occurred, a model number indicating a model, an error code indicating a type of the occurring error, a counter value which is the number of printed sheets at the time of occurrence of the error, and an error occurrence date and time.

The repairing part estimating unit 314 estimates an action to be executed to resolve an error occurring in the device. The repairing part estimating unit 314 determines whether the estimated action is a remotely executable action. A remotely executable action is an action that can be executed by remotely transmitting a command to the target network device via the network 100. On the other hand, a remotely non-executable action is an action that can be executed by operating the network device in an installation site of the network device.

When the operation information including the error information and the determination result are received from the error determining unit 312, the repairing part estimating unit 314 acquires a market result matching the model number and the error code included in the operation information from the market result managing unit 315. The repairing part estimating unit 314 ranks actions in the market result matching the repairing component and the component number included in the determination result and sets priorities in the order of decreasing likelihoods that the error will be resolved. A user (for example, a customer technician) can expect to resolve the occurring error by performing an action estimated for the device. The repairing part estimating unit 314 determines whether the estimated action is a remotely executable action. The repairing part estimating unit 314 stores the estimated action, the priority of the action, and the determination result indicating whether the action is a remotely executable action as an estimation result in the estimation result managing unit 316.

The repairing part estimating unit 314 stores remote action information for determining whether the estimated action is a remotely executable action. Table 2 is an example of the remote action information.

TABLE 2

| Model number | Action details |
|---|---|
| Model-001 | adjustment_firmware update |
| Model-001 | adjustment_set value change |
| Model-002 | adjustment_firmware update |
| Model-002 | adjustment_set value change |

The remote action information includes a model ID and action details. Actions defined as the remote action information shown in Table 2 are remotely executable actions. Examples of the remotely executable actions include control associated with software such as firmware update, application update, and set value update of firmware or applications. The repairing part estimating unit 314 determines that the estimated action is remotely executable when the estimated action is included in the remote action information and determines that the estimated action is not remotely executable when the estimated action is not included in the remote action information.

The market result managing unit 315 manages result information of all actions performed by a customer technician to resolve errors having occurred in the past as a market result. The market result managing unit 315 collects result information including a model number, an error code, and an action for each component number from the customer technician, counts an action number for each action, and stores and manages the count result. Table 3 is an example of a market result that is managed by the market result managing unit 315 according to the first embodiment.

TABLE 3

| Model | Error | Component | | Result |
|---|---|---|---|---|
| number | code | number | Action details | number |
| Model-001 | E001-0001 | Part1-111 | adjustment_firmware update | 880 |
| Model-001 | E001-0001 | Part2-222 | replacement_componentreplacement | 96 |
| Model-001 | E001-0001 | Part3-333 | adjustment_set value change | 14 |
| Model-001 | E001-0001 | Part4-444 | cleaning_cleaning of main installation | 7 |
| | | | position | |
| Model-001 | E001-0001 | Part5-555 | replacement_componentreplacement | 3 |
| Model-001 | E002-0002 | Part3-333 | adjustment_adjustment of main installation | 1088 |
| | | | position | |

The market result includes a model number indicating a model, an error code which is a type of an occurring error, a component number of a component subjected to an action for the error, action details indicating details of an executed action, and a result number indicating a result number of actions in the market.

The estimation result managing unit 316 stores and manages an estimation result of an action estimated by the repairing part estimating unit 314. Table 4 is an example of an estimation result that is managed by the estimation result managing unit 316.

TABLE 4

| | | | | | Whether remote | |
|---|---|---|---|---|---|---|
| | | Component | | | execution is | Remote |
| Device ID | Error ID | number | Action details | Priority | possible | result |
| DEV0000001 | Err-001 | Part1-111 | adjustment_firmware | 88 | TRUE | Unsupported |
| | | | update | | | |
| DEV0000001 | Err-001 | Part2-222 | replacement_component | 9.6 | FALSE | — |
| | | | replacement | | | |
| DEV0000001 | Err-001 | Part3-333 | adjustment_set value | 1.4 | TRUE | Unsupported |
| | | | change | | | |
| DEV0000001 | Err-001 | Part4-444 | cleaning_cleaning of | 0.7 | FALSE | — |
| | | | main installation | | | |
| | | | position | | | |
| DEV0000001 | Err-001 | Part5-555 | replacement_component | 0.3 | FALSE | — |
| | | | replacement | | | |
| DEV0000001 | Err-001 | Part5-555 | replacement_component | 54.4 | FALSE | — |
| | | | replacement | | | |

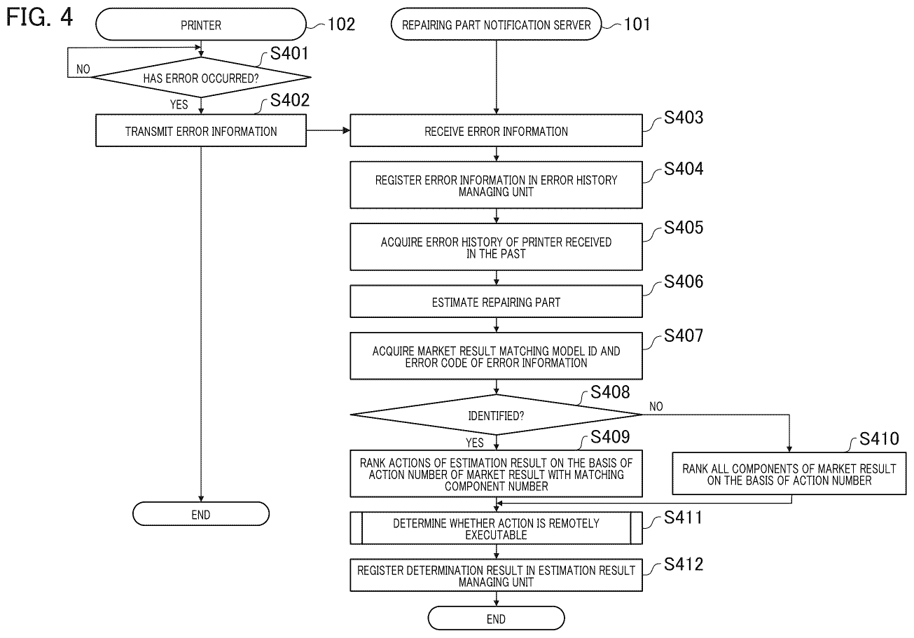

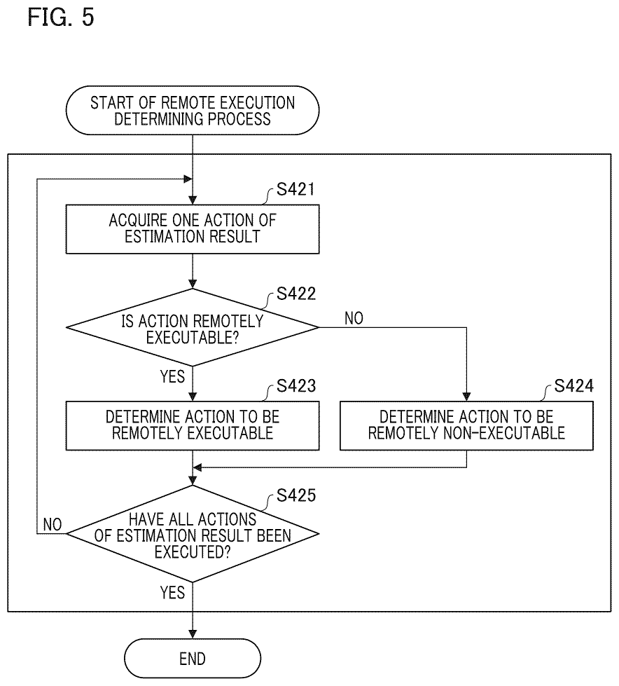

The estimation result includes a device ID, an error ID, a component number of a repairing component for the error, a priority indicating the ranking of priorities of actions, whether remote execution is possible, and a remote result. In this embodiment, it is assumed that the priority of an action becomes higher as the numerical value of the priority becomes higher. Whether remote execution is possible indicates whether the action is a remotely executable action, “TRUE” indicates that remote execution is possible, and “FALSE” indicates that remote execution is not possible. The remote result indicates an execution result of a remote executable action, a value of “executed” is stored when the corresponding error is resolved through the remote execution, a value of “non-executable” is stored when the corresponding error is not resolved, and a value of “unsupported” is stored when no remotely executable action is performed. An example of a method of calculating a priority or a method of determining whether remote execution is possible will be described later in an action estimating process illustrated in FIGS. 4 and 5 which will be described later.

The repairing sequence display unit 317 provides data for outputting information of candidates estimated by the repairing part estimating unit 314 as an action to be executed for an error occurring in the device. In this embodiment, when a remotely executable action is included as a candidate for an action to be recommended, data provided by the repairing sequence display unit 317 includes data for outputting information indicating that a remote job is recommended. In this embodiment, the repairing sequence display unit 317 generates a repairing sequence display screen in response to a repairing sequence acquisition request received from the PC 103 and provides the generated repairing sequence display screen to the PC 103. First, when the repairing sequence acquisition request including a device ID and an error ID is received from the browser 331 of the PC 103, the repairing sequence display unit 317 acquires an error history matching the device ID and the error ID from the error history managing unit 313. The repairing sequence display unit 317 also acquires an estimation result matching the device ID and the error ID from the estimation result managing unit 316, generates a repairing sequence display screen, and provides the generated repairing sequence display screen to the PC 103 via the browser 331 such that the repairing sequence display screen is displayed. The external I/F 318 is an interface for transmitting and receiving data or instructions to and from another server such as the remote control server 104. The external I/F 318 is defined as an application programming interface (API) for external connection and can exchange data via the API. The printer 102 includes an operation information transmitting unit 321, a job executing unit 322, a control unit 323, and a remote control unit 324. The operation information transmitting unit 321 transmits operation information including error information occurring in the printer 102 and collected by the control unit 323 which will be described later to the repairing part notification server 101. The job executing unit 322 executes a job input to the printer 102. For example, when a printing job is input, the job executing unit 322 performs a printing process on the basis of the printing job.

The control unit 323 detects an error occurring in the printer 102, collects error information, and transmits the error information to the repairing part notification server 101 via the operation information transmitting unit 321. The remote control unit 324 receives a remote control instruction from the remote control server 104 and performs a process on the software of the printer 102. For example, the remote control unit 324 performs update of firmware or applications, change of set values, and the like on the basis of the remote control instruction. The remote control unit 324 transmits identification information of firmware or applications of the printer 102 or information on remote control such as a version of software to the remote control server 104.

The remote control server 104 includes a remote control transmitting and receiving unit 341, a remote control unit 342, a printer information managing unit 343, a software information managing unit 344, a remote control display unit 345, and an external I/F 346. The remote control transmitting and receiving unit 341 transmits and receives information for remote control to and from the printer 102. Information transmitted from the remote control transmitting and receiving unit 341 to the printer 102 includes, for example, an instruction to update firmware or applications installed in the printer 102 and an instruction to change set values of the software. The remote control transmitting and receiving unit 341 receives identification information of firmware or applications, version information of software, and information of set values of the software from the printer 102.

The remote control unit 342 processes remote control information for the printer 102. Specifically, the remote control unit 342 performs determination of whether remote control is possible or identification of software information to be transmitted to the printer 102 on the basis of model information of the printer 102 managed by the printer information managing unit 343 or information of set values for the remote control. The remote control unit 342 acquires the identified software information from the software information managing unit 344 and instructs the remote control transmitting and receiving unit 341 to transmit the acquired information to the printer 102.

The printer information managing unit 343 manages information on the printer 102. Specifically, the printer information managing unit 343 manages model information indicating the device ID for identifying the printer 102 or a model, set values for the remote control of the printer 102, and the like. The set values for the remote control include, for example, information indicating whether remote control of the printer 102 is permitted and remote control information which is currently instructed to the printer 102.

The software information managing unit 344 manages software information of firmware or applications transmitted to the printer 102. Specifically, the software information managing unit 344 manages identification information or version information of software, module files constituting the software, set values of the software, and the like. The software information managing unit 344 manages the software information in correlation with the model information of the printer 102. The software information managing unit 344 can instruct remote control of the printer 102 by transmitting remote control information to the printer 102 via the remote control transmitting and receiving unit 341.

The remote control display unit 345 provides remote control information for the printer 102 which is displayed on the browser 331 of the PC 103. Specifically, when a request for displaying a remote control screen is received from the PC 103, the remote control display unit 345 acquires software information of the printer 102 via the remote control unit 342 and generates and returns a remote control display screen to the browser 331. The remote control display unit 345 receives a remote control instruction for the printer 102 through an operation on the remote control display screen and transmits the remote control instruction to the remote control unit 342. The external I/F 346 is an interface for transmitting and receiving data or instructions to and from another service such as the repairing part notification server 101. The external I/F 346 is defined as an API for external connection and can exchange data via the API.

A process of estimating an action for resolving an error in a network device and determining whether the action is a remotely executable action will be described below. A result of this process is stored in the estimation result managing unit 316 and is provided to a technician or the like via the browser 331 when a display request is received from the PC 103. FIG. 4 is a flowchart illustrating an action estimating process. In the action estimating process, a process that is performed by the printer 102 is realized by causing the CPU 231 of the printer 102 to read a program or resource data stored in the memory (such as the ROM 232 or the external memory 236) and execute the program. In the action estimating process, a process that is performed by the repairing part notification server 101 is realized by causing the CPU 201 of the repairing part notification server 101 to read a program or resource data stored in the memory (such as the ROM 202 or the HDD 204) and execute the program.

In S401, the control unit 323 of the printer 102 detects whether an error has occurred in the printer 102. When it is detected that an error has occurred, the control unit 323 performs the process of S402. When it is detected that an error has not occurred, the control unit 323 repeats the process of S401. In S402, the operation information transmitting unit 321 of the printer 102 transmits operation information including error information of the error detected in S401 to the repairing part notification server 101. The operation information including error information transmitted by the operation information transmitting unit 321 includes an error ID for uniquely identifying an error, a device ID and a model number which are information of a device, an error code indicating the error, a counter value which is the number of printed sheets at the time of occurrence of the error, and an error occurrence date and time. That is, the operation information transmitting unit 321 of the printer 102 transmits information managed as an error history by the error history managing unit 313 of the repairing part notification server 101 to the repairing part notification server 101. In this embodiment, the counter value is included in the operation information, but the counter value may be handled, for example, as counter information and transmitted as information other than the operation information including error information to the repairing part notification server 101. When the counter information is transmitted separately from the operation information including error information, the repairing part notification server 101 correlates the counter information with the error information.

In S403, the operation information receiving unit 311 of the repairing part notification server 101 receives the operation information including error information from the printer 102. In S404, the error determining unit 312 registers the operation information including error information received from the printer 102 as an error history in the error history managing unit 313. In S405, the error determining unit 312 acquires an error history received in the past from the printer serving as a source of the error information received in S403 out of error histories managed by the error history managing unit 313. Specifically, the error determining unit 312 acquires an error history matching the device ID included in the received operation information including error information. For example, when the device ID included in the error information is “DEV0000001,” the error determining unit 312 acquires records in the first row and the third row of Table 1. Then, the error determining unit 312 sends the operation information including error information received from the printer 102 and the error history of the printer 102 acquired in S405 to the repairing part estimating unit 314.

In S406, the repairing part estimating unit 314 estimates an action for resolving the error occurring in the printer 102. In this embodiment, for example, it is assumed that a component to be handled is estimated as the action for resolving the error. Specifically, the repairing part estimating unit 314 calculates a list of a plurality of component numbers indicating repairing components to be handled to resolve an error based on a rule base using the error information received from the printer 102 and the error history acquired from the error history managing unit 313. In estimation of a repairing part in Step S406, the repairing part estimating unit 314 may not be able to identify repairing components to be handled. An example of this case is an error for which a rule is not present in the rule base. When repairing components are not identified, that is, when an action for resolving the error is not estimated, the error determining unit 312 outputs a list of empty component numbers indicating that determination is not possible. In this embodiment, an example in which the error determining unit 312 employs a method using a rule base based on the received error information and error histories occurring in the past in the same device is described, but identification of a repairing component is not limited thereto. For example, estimation using machine learning including deep learning may be performed.

In S407, the repairing part estimating unit 314 acquires a market action result matching the model number and the error code in the error information from the market result managing unit 315. For example, when the model number and the error code included in the error information are “Model-001” and “E001-0001,” the repairing part estimating unit 314 acquires records of the first to fifth rows in Table 3.

In S408, the repairing part estimating unit 314 checks whether an action has been identified. In this embodiment, the repairing part estimating unit 314 checks whether a repairing component has been identified as an action. Whether a repairing component has been identified is determined on the basis of whether a component number in the list of component numbers is empty. Specifically, when a list of empty component numbers is output in S406, the repairing part estimating unit 314 determines that a repairing component has not been identified and performs the process of S410. On the other hand, when a list of empty component numbers is not output, the repairing part estimating unit 314 determines that a repairing component has been identified and performs the process of S409.

In S409, the repairing part estimating unit 314 ranks the estimated actions and set priorities thereof. Specifically, the repairing part estimating unit 314 acquires an action result number matching the component number from the market result acquired in S407 for each component number included in the list of component numbers calculated in S406. Then, the repairing part estimating unit 314 ranks the component numbers (actions) on the basis of the action result number and sets priorities thereof. The repairing part estimating unit 314 correlates the priorities of which each is “(action result number of repairing component/total number of action results of all components handled for error)×100” with the component numbers. That is, the repairing part estimating unit 314 calculates the priorities in the units of components such that the total sum of the priorities of all the components subjected to the actions for the error code occurring in a certain model is 100%. In this embodiment, the priority is calculated as a ratio of the action result number of a repairing component to the total action result number of all the repairing components to be handled, but a priority calculating method is not limited to the method according to this embodiment and may be any method. For example, it is assumed that the list of component numbers is [Part1-111, Part2-222, Part3-333, Part4-444, Part5-555] and the market result acquired in S407 corresponds to the first to fifth rows in Table 3. In this case, the total action result number of all the components in the action result is 1000 which is the sum of the action numbers in the market result. At this time, the priority of the component number “Part1-111” is calculated as “(880/1000)×100=88.0.” Similarly, the priorities of the other component numbers “Part2-222,” “Part3-333,” “Part4-444,” and “Part5-555” are calculated as “9.6,” “1.4,” “0.7,” and “0.3.”

In S410, the repairing part estimating unit 314 calculates the priorities of all the component numbers (records) in the market result acquired in S407 using the same method as in S409. For example, it is assumed that the market result acquired in S407 includes the first to fifth rows in Table 3. In this case, the repairing part estimating unit 314 calculates the priorities of 5 component numbers “Part1-111,” “Part2-222,” “Part3-333,” “Part4-444,” and “Part5-555” included in the market result and correlates the component numbers and the priorities using the priorities as the estimation result.

Then, in S411, the repairing part estimating unit 314 determines whether the action is a remotely executable action for the estimation result calculated in S409 or S410. Details of the remote execution determining process of S411 will be described below with reference to FIG. 5. FIG. 5 is a flowchart illustrating the remote execution determining process according to the first embodiment. The remote execution determining process is realized by causing the CPU 201 of the repairing part notification server 101 to read a program or resource data stored in the memory (such as the ROM 202 or the HDD 204) and to execute the program.

In S421, the repairing part estimating unit 314 acquires one action calculated as the estimation result. In S422, the repairing part estimating unit 314 determines whether the action acquired in S421 is a remotely executable action. Specifically, the repairing part estimating unit 314 determines whether a model ID of the action calculated as the estimation result and an action identified from action details are present in the remote action information shown in Table 2. When they are present in the remote action information, the repairing part estimating unit 314 determines that remote execution is possible (TRUE) and performs the process of S423. In S423, the repairing part estimating unit 314 determines that the action acquired in S421 is a remotely executable action. On the other hand, when they are not present in the remote action information, the repairing part estimating unit 314 determines that remote execution is not possible (FALSE) and performs the process of S424. In S424, the repairing part estimating unit 314 determines that the action acquired in S421 is a remotely non-executable action.

In S425, the repairing part estimating unit 314 determines whether the remote execution determining process has been performed on all the actions calculated as the estimation result. When the remote execution determining process has been performed on all the actions calculated as the estimation result, the repairing part estimating unit 314 ends the remote execution determining process and performs the process of S412 illustrated in FIG. 4. On the other hand, when the remote execution determining process has not been performed on all the actions calculated as the estimation result, the repairing part estimating unit 314 performs the process of S421 again.

Description will be continued with reference back to FIG. 4. In S412, the repairing part estimating unit 314 registers the estimation result of the actions for the error including the result of the remote execution determining process of S411 in the estimation result managing unit 316. Specifically, the repairing part estimating unit 314 registers the component number and the priority in the result of the remote execution determining process along with a device ID and an error ID in the error information as an estimation result in the estimation result managing unit 316. For example, the estimation result including the component number, the priority, and the remote excitability calculated in the processes of S409 to S411 corresponds to the first to fifth rows in Table 4. Through the aforementioned processes, the repairing part notification server 101 can perform estimation of an action (a repairing component), setting of the priority of the action, and determination of whether remote execution is possible for an error occurring in the printer 102.

When a technician or the like taking charge of maintenance of the printer 102 checks an action which is recommended for an error of the printer 102, the browser 331 of the PC 103 displays a repairing component display screen which is provided by the repairing part notification server 101. Specifically, the repairing sequence display unit 317 of the repairing part notification server 101 receives a repairing sequence acquisition request including a device ID and an error ID via the browser 331 of the PC 103. The repairing sequence display unit 317 acquires an estimation result registered in the estimation result managing unit 316 in S412 on the basis of the repairing sequence acquisition request, generates a repairing component display screen based on the estimation result, and provides the repairing component display screen to the PC 103. The repairing part notification server 101 displays a repairing sequence for resolving an error for each error. The CPU of the PC 103 displays the repairing component display screen provided from the repairing part notification server 101 via the browser 331 on the display of the PC 103.

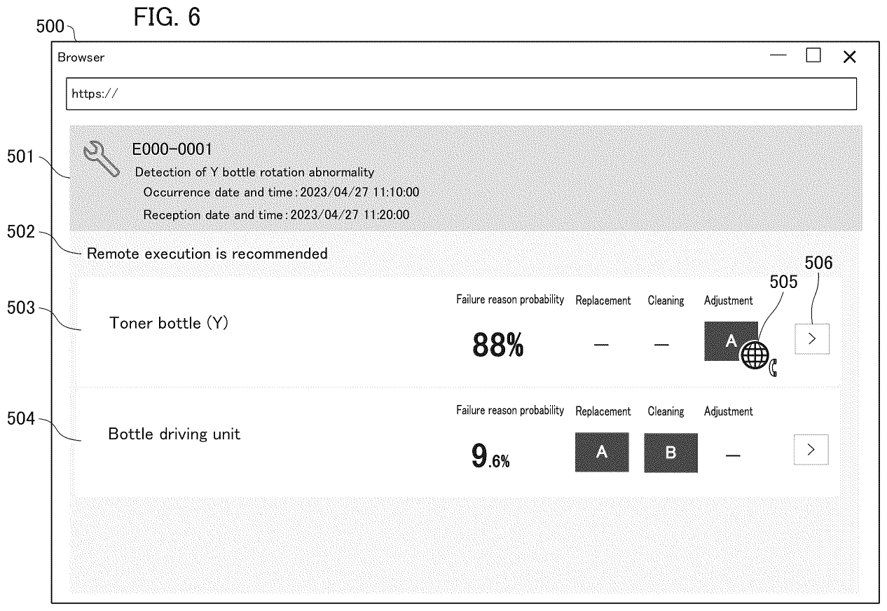

FIGS. 6 to 10 are diagrams illustrating an example of the repairing sequence display screen displayed on the browser 331. A repairing sequence display screen 500 illustrated in FIG. 6 displays an error history and an estimation result which are managed by the repairing part notification server 101. Information of an error identified by the error ID designated via the browser 331 of the PC 103 is displayed in error information 501. For example, the error information 501 includes an error ID, details of an error, an occurrence date and time of the error, and a reception date and time at which the repairing part notification server 101 is notified of occurrence of the error from the printer 102. In the example illustrated in FIG. 6, an error code E000-0001 and error details “detection of Y bottle rotation abnormality” are displayed as the error information. This represents a state in which an error has occurred because the printer 102 has detected an abnormality of bottle rotation of a toner bottle (Y).

A message 502 is a message for a repairing sequence. When the estimated actions include a remotely executable action, a message for recommending remote execution is displayed in the message 502. The repairing sequence display unit 317 displays the message for recommending remote execution when an estimation result is remotely executable with reference to the estimation result registered by the estimation result managing unit 316.

Action information 503 and action information 504 indicate a component with a likelihood of a reason for the error and an action for resolving the error. The repairing sequence display unit 317 displays the action information 503 and the action information 504 with reference to the estimation result registered by the estimation result managing unit 316. The action information 503 indicates a remotely executable action, and the action information 504 indicates a remotely non-executable action. The action information 503 indicates a state in which “toner bottle (Y)” has a failure reason probability “88%” and “adjustment” is presented as a necessary action and displays that the action is remotely executable using a remotely executable icon 505. The remotely executable icon 505 is an example of a display of remote execution recommendation. For example, it is assumed that an error considered as an abnormality occurs in a printer of the same model as the printer 102 and is registered in a market result because a rotation speed of a toner bottle (Y) mounted in the printer matches a threshold value with which firmware of a specific version considers the rotation speed as “detection of Y bottle rotation abnormality.” Regarding the error of detection of Y bottle rotation abnormality having occurred in the printer 102, the repairing part notification server 101 considers that the error can be resolved by updating the version of the firmware to an appropriate version and presents the action information 503. As displayed on the repairing sequence display screen 500, in this embodiment, one or both of the message for recommending remote execution and the display (icon) of remote execution recommendation for the target action are displayed on the repairing sequence display screen 500. Accordingly, data provided by the repairing sequence display unit 317 includes data for outputting one or both of the message for recommending remote execution and the display of remote execution recommendation as data for outputting information indicating that a remote job is recommended.

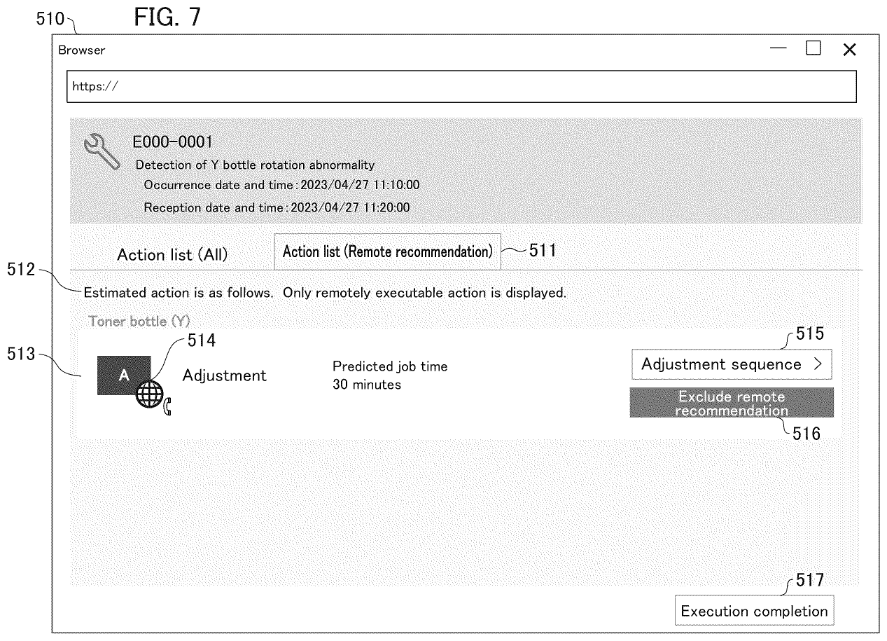

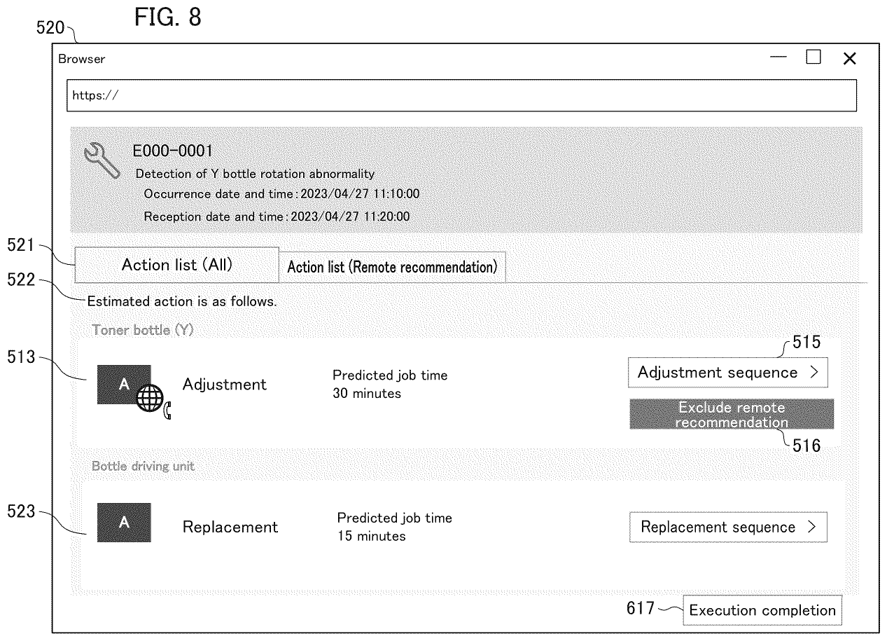

The action information 504 indicates that a probability with which a “bottle driving unit” is a failure reason is “9.6%” and “replacement” and “cleaning” are presented as a necessary action. Here, replacement is displayed as “A,” and cleaning is displayed as “B,” which represents priorities of actions out of actions for the same component. The priorities are defined as A>B>C. Since these actions are remotely non-executable actions, the remotely executable icon 505 is not displayed. A button 506 is a button for transitioning to display of an action list corresponding to action information. By pushing the button 506, the screen can transition to display of an action list (FIGS. 7 and 8) which will be described later.

A repairing sequence display screen 510 illustrated in FIG. 7 indicates a state in which a list of remotely executable actions to be recommended is displayed. A tab 511 is a tab “process list (remote recommendation)” and displays only actions of which remote execution is recommended. A message 512 is a message for the action list. For example, when a technician handling an error is a technician of remote execution (a remote technician), the remote technician displays the tab 511 for displaying only actions of which remote execution is recommended and performs a job.

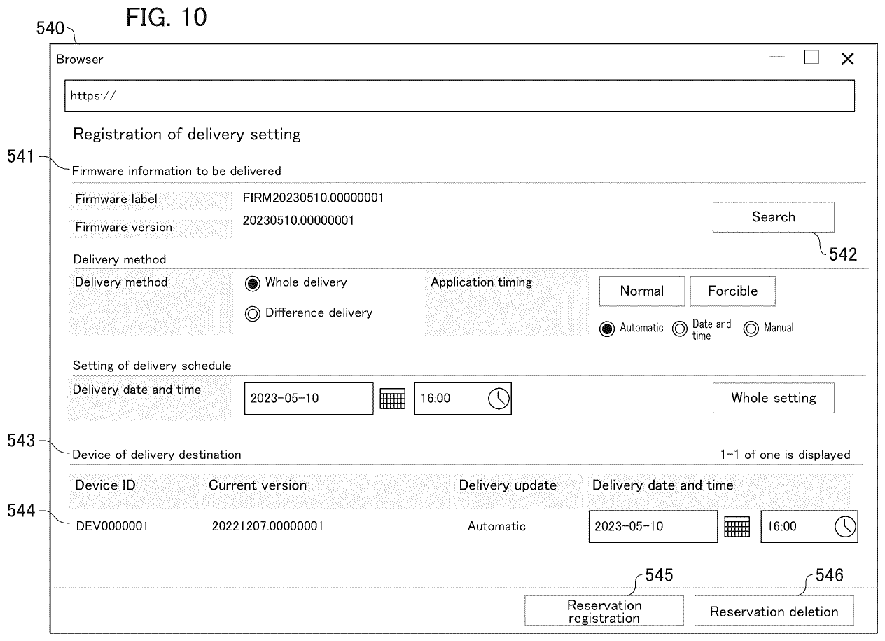

The message 512 indicates a state in which only remotely executable actions are displayed in the list. An action information 513 indicates a remotely executable action. In the action information 513, an action “adjustment” for the toner bottle (Y), a job reference time, an icon 514 indicating that the action is a remotely executable action, a button 515 for checking an adjustment sequence, a button 516 for excluding remote recommendation, and an execution completion button 517 are displayed. By pushing the button 515, the screen can transition to an adjustment sequence check screen (not illustrated) for displaying a specific sequence of an “adjustment” job. By displaying a button for remote control on the adjustment sequence check screen and pushing the button, a remote control display screen (FIG. 10) of the remote control server 104 can be displayed.

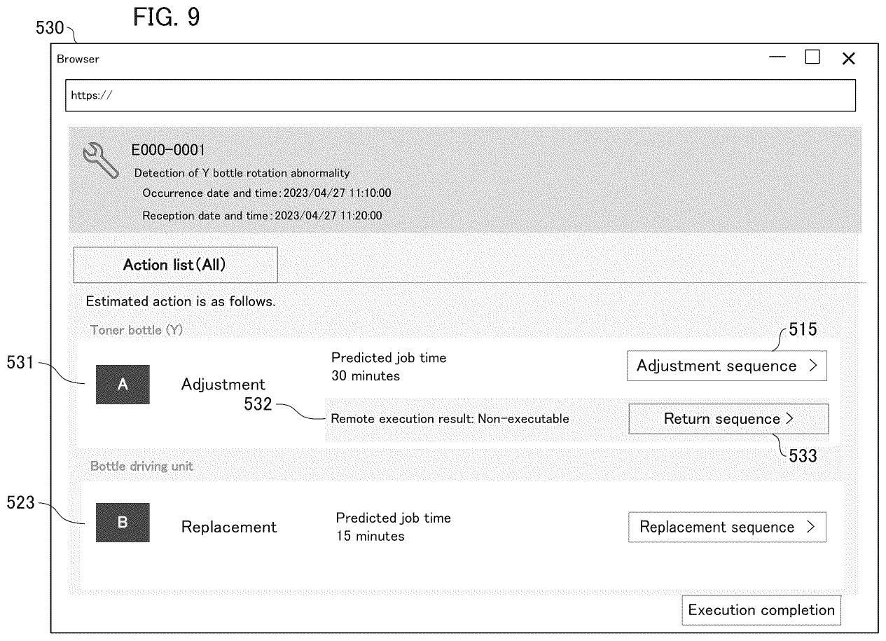

The button 516 for excluding remote recommendation is a button for excluding remote recommendation of an estimated action. By pushing the button 516 for excluding remote recommendation, it is possible to release recommendation of remote execution. For example, when the error cannot be resolved as a result of trial of remote execution, the technician releases recommendation of remote execution by pushing the button 516 for excluding remote recommendation. A screen after remote recommendation has been released is illustrated in FIG. 9 which will be described later. The execution completion button 517 is a button which is pushed when execution has been completed through the estimated action. By pushing the execution completion button 517, feedback information such as information indicating that execution has been completed through the estimated action and information indicating a time required for the action is input, and execution is completed. The feedback information is stored and managed as market action result information by the market result managing unit 315 of the repairing part notification server 101.

A repairing sequence display screen 520 illustrated in FIG. 8 indicates a state in which a list of all actions is displayed. The repairing sequence display screen 510 displays only actions of which remote execution is recommended, and the repairing sequence display screen 520 displays all actions including the actions of which remote execution is recommended. A tab 521 is a tab of “action list (all)” and displays all actions acquired as an estimation result and including actions of which remote execution is recommended and actions of which remote execution is not recommended. For example, a remote technician displays the tab 511 for displaying only actions of which remote execution is recommended and performs a job, and a technician other than the remote technician displays a tab 521 for displaying all actions and performs a job. For example, the tab 521 for displaying all actions is based on the assumption that the tab 521 is checked by a dispatcher or the like who checks error details and an action for the error and asks a remote technician or a customer technician moving to a customer and performing a job.

A message 522 is a message for an action list. In the tab 521 for displaying all actions, remotely non-executable action information 523 in addition to the remotely executable action information 513 is displayed. In this embodiment, a configuration in which details which can be checked by changing a screen using a tab (the tab 511 and the tab 521) are changed is employed, but the display changing method is not limited thereto. For example, a configuration in which an action to be displayed is stored as role information of a user or information of set values of a user and display is changed according to values thereof may be employed.

A repairing sequence display screen 530 illustrated in FIG. 9 indicates a state in which actions of which remote execution is recommended are excluded from actions of which remote execution is recommended in the state in which a list of all actions is displayed. Action information 531 of the repairing sequence display screen 520 indicates a state in which remote recommendation of the action information 513 is released by pushing the button 516 for excluding remote recommendation in the repairing sequence display screen 510 illustrated in FIG. 8. A display 532 indicating that the remote execution result is not remotely executable is added to the action information 531, and a button 533 for checking a recovery sequence for returning the remote execution to the original state is displayed instead of the button 516 for excluding remote recommendation. When a remotely executed action needs to be returned to a pre-execution state, a detailed sequence for returning a remotely executed action to a pre-execution state can be checked by pushing the button 533.

A repairing sequence display screen 540 illustrated in FIG. 10 indicates a remote control display screen. The remote control display screen is a remote control screen that is displayed before the button 515 for displaying a remote action sequence of the action information 513 of which remote execution is recommended is pushed. The remote control display screen is a screen for reserving a delivery instruction of update of firmware, update of set value, or the like which is remote action details for the printer 102 and is displayed by the remote control display unit 345 of the remote control server 104.

FIG. 10 illustrates an example of a setting screen for updating firmware as a remote executable action. On the repairing sequence display screen 540, a screen for a firmware delivery instruction to the printer 102 of which an error is displayed on the repairing sequence display screen 500 is displayed. Information for identifying firmware delivered to the printer 102 is displayed in firmware information 541. The firmware displayed in the firmware information 541 and to be delivered can be changed by selecting target firmware on a firmware selection screen (not illustrated) which is displayed by pushing a search button 542.

Information of a device which is a firmware delivery destination is displayed in device information 543. In the example illustrated in FIG. 10, information indicating the printer 102 of which an error is displayed on the repairing sequence display screen 500 is displayed as a delivery destination of an instruction to update firmware. In the device information 543, for example, a device ID 544 for uniquely identifying a device, version information of current firmware delivered to the device, and information such as a delivery update indicating designation of a delivery method or a delivery date and time for designating a date and time at which it is delivered are displayed. A reservation registration button 545 is a button for reserving an instruction to deliver details set on the repairing sequence display screen 540. By pushing the reservation registration button 545, a delivery instruction to the printer 102 is reserved. When execution of the reservation registration button 545 is accepted by the control display unit 345, the remote control display unit 345 transmits information designated on the repairing sequence display screen 540 to the remote control unit 342. A reservation deletion button 546 is a button for closing the repairing sequence display screen 540 which is a screen for a firmware delivery instruction. The remote control unit 342 generates remote control information on the basis of information received from the remote control display unit 345 and transmits the generated remote control information to the printer 102. Accordingly, it is possible to instruct the printer 102 to update firmware or to update set values and to remotely execute an action for an error.

In this embodiment, identifying a repairing component to be handled at a timing at which error information is received from the printer 102 (S406), calculating a priority (S409 and S410), and determining whether remote execution is possible (S411 to S415) are performed, but the present disclosure is not limited thereto. For example, only identifying a repairing component may be performed at a timing at which error information is received, and calculating a priority or determining whether remote execution is possible may be performed at a timing at which a repairing sequence acquisition request is received from the browser 331 of the PC 103.

In this embodiment, display for recommending remote execution for all estimation results of remote executable actions is performed with reference to the estimation results registered by the estimation result managing unit 316, but the present disclosure is not limited thereto. For example, when the probability of the estimation result is low, display for recommending remote execution may not be performed. Accordingly, the repairing sequence display unit 317 displays recommendation of remote execution only when a value of a failure reason probability corresponding to the estimation result is equal to or greater than a threshold value with reference to the estimation result. As a result, only when the probability that the error will be resolved by a remote action is higher than a predetermined probability, it is possible to display recommendation of remote execution.

As described above, according to this embodiment, error information from a device is received, a repairing part of the reason is estimated from the error information, it is determined whether action details thereof is remotely executable, and data for recommending remote execution is provided when remote execution is possible. Accordingly, an technician can recognize an action of which remote execution is recommended.

### Second Embodiment

In the first embodiment, the number of actions recorded as a market result is one, but a plurality of actions such as both of “component replacement” and “firmware update” may be needed. When a plurality of actions are needed, the order of a job sequence may be constrained such as the order of jobs of “component replacement” and “firmware update.” In this way, when a plurality of actions are needed, whether remote execution is possible cannot be simply determined based on whether estimated action details are present in the remote action information shown in Table 2 as in the first embodiment. Therefore, in this embodiment, when an action for resolving an error includes a plurality of items, whether remote execution is possible is determined in consideration of whether each action is remotely executable and whether a job sequence of the action is constrained. In the following description, the same constituents and processes as in the first embodiment will be referred to by the same reference signs, description thereof will be omitted, and only differences from the first embodiment will be described.

Table 5 is an example of a market result managed by the market result managing unit 315 according to the second embodiment. The market result (table 3) described in the first embodiment includes one action as action details, but a market result (Table 5) according to this embodiment includes a plurality of actions as action details such as records in the sixth and seventh rows. The market result according to this embodiment includes a sequence constraint indicating a constraint of a job sequence of action details in addition to a model number, an error code, a component number, action details, and a result number. In the sequence constraint, information indicating whether a job sequence of an action is constrained when there are a plurality of action details is stored.

For example, the records in the sixth and seventh rows of Table 5 include a plurality of action details. This represents that a plurality of jobs are required as an action for the error. The record in the sixth row includes two action details such as “replacement_component replacement” and “adjustment_firmware update,” and the sequence constraint is “no.” Accordingly, the job sequence for executing two actions including “replacement_component replacement” and “adjustment_firmware update” does not have to the order in the list. On the other hand, the record in the seventh row include two action details such as “replacement_component replacement” and “adjustment_firmware update,” and the sequence constraint is “yes.” Accordingly, the job sequence for executing two actions including “replacement_component replacement” and “adjustment_firmware update” is constrained such as “adjustment_firmware update” is executed after “replacement_component replacement” is executed.

TABLE 5

| Model | Error | Component | | Sequence | Result |
|---|---|---|---|---|---|
| number | code | number | Action details | constraint | value |
| Model-001 | E001- | Part1-111 | adjustment_firmware update | — | 880 |
| | 0001 | | | | |
| Model-001 | E001- | Part2-222 | replacement_component | — | 96 |
| | 0001 | | replacement | | |
| Model-001 | E001- | Part3-333 | adjustment_set value change | — | 14 |
| | 0001 | | | | |
| Model-001 | E001- | Part4-444 | cleaning_cleaning of main | — | 7 |
| | 0001 | | installation part | | |
| Model-001 | E001- | Part5-555 | replacement_component | — | 3 |
| | 0001 | | replacement | | |
| Model-001 | E003- | Part6-666 | replacement_component | No | 536 |
| | 0003 | | replacement | | |
| | | | adjustment_firmware update | | |
| Model-001 | E004- | Part7-777 | replacement_component | Yes | 667 |
| | 0004 | | replacement | | |
| | | | adjustment_firmware update | | |

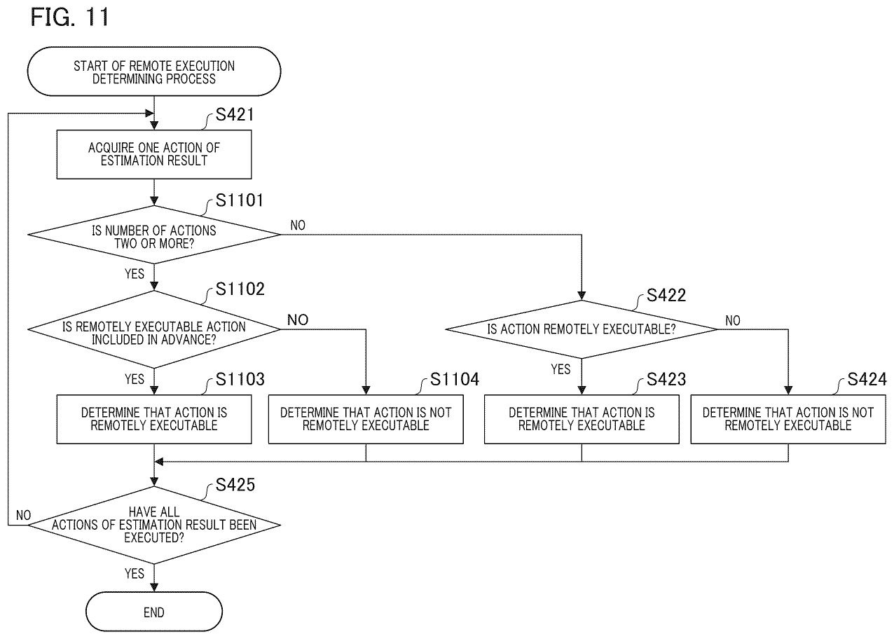

FIG. 11 is a flowchart illustrating a remote execution determining process according to the second embodiment. This process is a process that is performed in S411 of the action estimating process (FIG. 4). In the remote execution determining process according to the second embodiment, a plurality of actions are included in the action details, and processing is performed in consideration of a case in which the job sequence is constrained. The remote execution determining process is realized by causing the CPU 201 of the repairing part notification server 101 to read a program or resource data stored in the memory (such as the ROM 202 or the HDD 204) and to execute the program.

In S411, the repairing part estimating unit 314 acquires one action calculated as an estimation result. In S1101, the repairing part estimating unit 314 determines whether the number of process details of the action acquired in S411 is two or more. For example, the determination result is yes when a plurality of action details are included as in the sixth and seventh rows of Table 5. When the number of process details is two or more, the process of S1102 is performed. On the other hand, when the number of process details is one, the process of S422 is performed.

In S1102, the repairing part estimating unit 314 determines whether a remotely executable action is included in advance. When there is a remotely executable action and the processing sequence is not constrained and when there is a remotely executable action and the processing sequence is constrained but the remotely executable action is to be first executed, it is determined that a remotely executable action is included in advance. On the other hand, when there is no remotely executable action and when there is a remotely executable action but the remotely executable action is not to be first executed due to constraint of the processing sequence, it is determined that a remotely executable action is not included in advance. The repairing part estimating unit 314 first determines whether a plurality of action details which are the estimation result acquired in S421 include a remotely executable action. Specifically, the repairing part estimating unit 314 determines whether each action identified by the model ID and the action details in the estimation result is present in the remote action information shown in Table 2. When a remotely executable action is included, the repairing part estimating unit 314 determines whether remote execution is possible in advance in consideration of a job sequence of the action. When the sequence constraint in Table 5 is “no,” the repairing part estimating unit 314 determines that remote execution is possible in advance. When the sequence constraint is “yes,” the repairing part estimating unit 314 determines that remote execution is possible only when there is no remotely non-executable action before the remotely executable action in the order in the list of process details in Table 5. Otherwise, the repairing part estimating unit 314 determines that remote execution is not possible. When it is determined that a remotely executable action is include in advanced, the process of S1103 is performed. In S1103, the repairing part estimating unit 314 determines that the estimation result is remotely executable (TRUE). On the other hand, when it is determined that a remotely executable action is not included in advance, the process of S1104 is performed. In S1104, the repairing part estimating unit 314 determines that the estimation result is remotely non-executable (FALSE). When the process of S1103 or S1104 is completed, the process of S425 is performed. Through the processes of S1101 to S1104, it is possible to determine whether a remotely executable action is executed in advance in consideration of whether the remotely executable action includes a plurality of action details and the sequence constraint of the action.

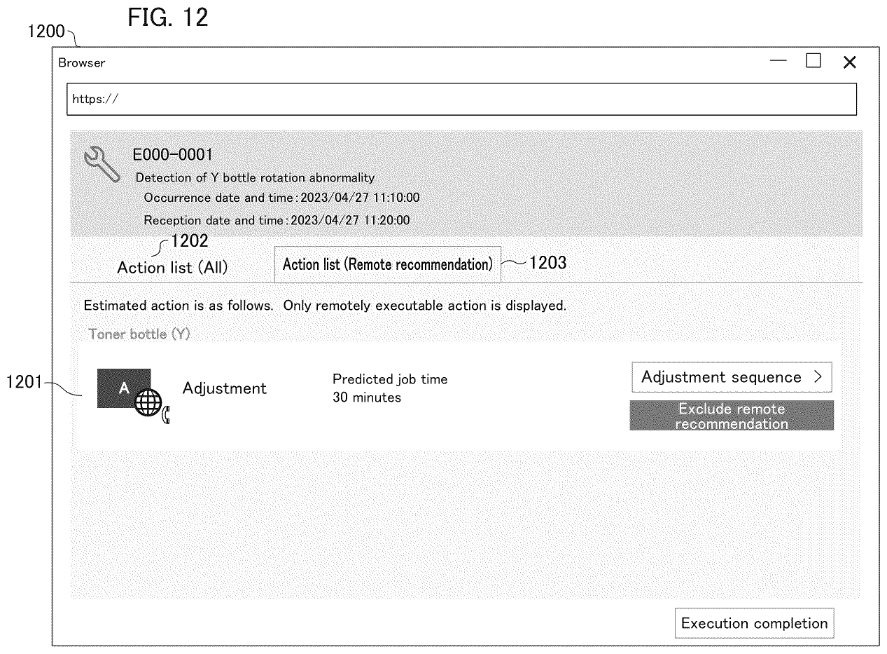

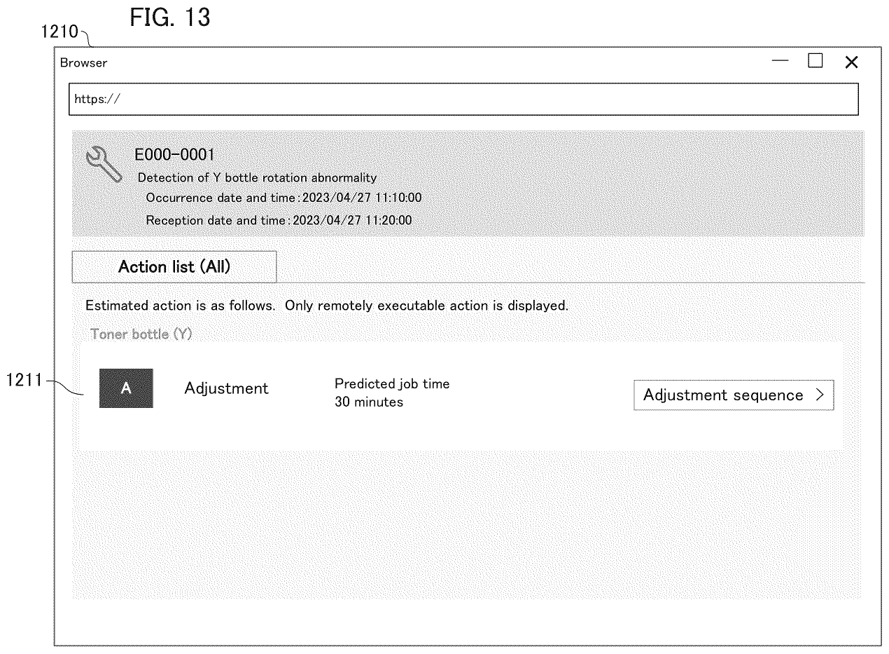

FIGS. 12 and 13 are diagrams illustrating an example of a repairing sequence display screen according to the second embodiment. Display when a plurality of action details are included as in the sixth and seventh rows of Table 5 is illustrated. A repairing sequence display screen 1200 illustrated in FIG. 12 is a screen example in which only an action of which remote execution is recommended is displayed. This example is an example of a screen that is displayed when it is determined in S1103 that remote execution is possible as the result of determination of the remote execution determining process, and an action indicated by action information 1201 is displayed as remote recommendation. The repairing sequence display screen 1200 includes a tab 1202 for displaying all actions acquired as the estimation result and a tab 1203 for displaying only actions of which remote execution is recommended and switches display of an action list by selecting the tabs. On the other hand, the repairing sequence display screen 1200 illustrated in FIG. 13 is a screen example in which all actions are displayed. This example is an example of a screen that is displayed when it is determined in S1104 that remote execution is not possible as the result of determination of the remote execution determining process, and a remotely non-executable action is displayed in the action information 1211.

As described above, according to this embodiment, when a plurality of actions are included as an action acquired as the estimation result, it is possible to determine whether remote execution is possible in consideration of constraint of a job sequence thereof or the like and to perform display for recommending remote execution only when it is determined that remote execution is possible.

### Third Embodiment

In the first embodiment and the second embodiment, whether action details are remotely executable is determined based on only whether the action details are present in the remote action information (Table 2). There may be an action of which remote execution is determined to be possible or not depending on only determination based on remote action information, and there may also be an action of which remote execution is not possible due to constraint on the printer 102 side or the like but of which remote execution is possible in the remote action information. For example, when remote control such as firmware update is performed, it may be considered that remote control is not permitted in some printers 102. In this case, update is not performed even when remote control information for instructing firmware update is transmitted to the printer 102 via the remote control server 104. Therefore, in this embodiment, a configuration in which the remote control server 104 is inquired about an action determined to be remotely executable by the repairing part notification server 101 and it is determined whether remote execution is possible will be described. In the following description, the same constituents and processes as in the first embodiment will be referred to by the same reference signs, description thereof will be omitted, and only differences from the first embodiment will be described.

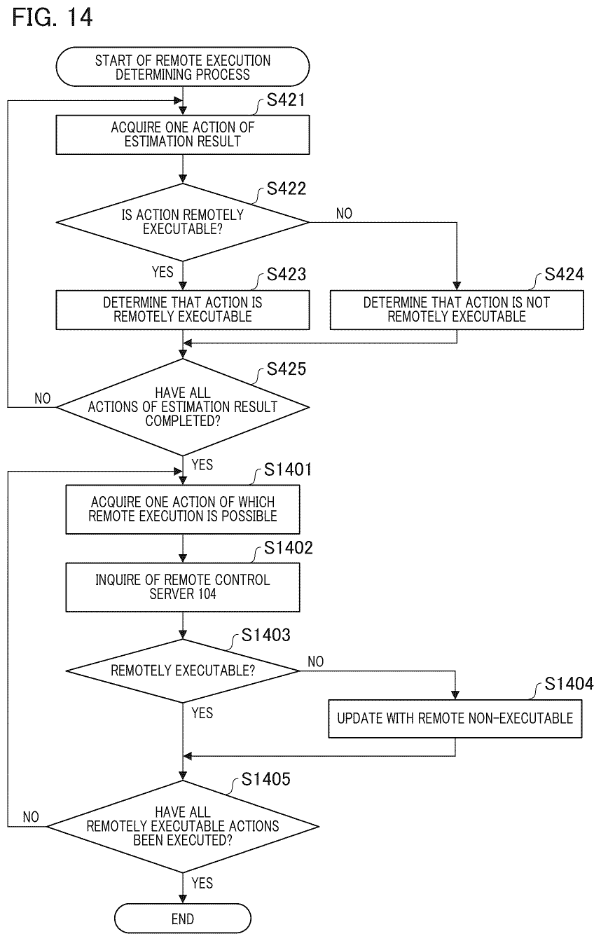

FIG. 14 is a flowchart illustrating a remote execution determining process according to a third embodiment. This process is a process that is performed in S411 of the action estimating process (FIG. 4). In the remote execution determining process according to the third embodiment, the remote control server 104 is inquired about an action of which remote execution is determined to be possible, and a process of determining whether an action determined to be remotely executable in a previous process for a printer 102 to be processed is remotely controllable is performed. The remote execution determining process is realized by causing the CPU 201 of the repairing part notification server 101 to read a program or resource data stored in the memory (such as the ROM 202 or the HDD 204) and to execute the program.

In S801, the repairing part estimating unit 314 acquires one remotely executable action (that is, a record including action details of which remote execution is “TRUE” in Table 4) from the estimation result. In S802, the repairing part estimating unit 314 inquires of the remote control server 104 about whether remote control of the printer 102 is possible via the external I/F 318. Specifically, an API of the remote control server 104 is called using a device ID for identifying the printer 102 and a remote control type corresponding to action details as parameters. The remote control type is a value obtained by converting the action details to definition of the remote control server 104. For example, the remote control type of “adjustment-firmware update” is “firmware update” in the definition of the remote control server 104, and the remote control type of “adjustment-set value change” is “set value change” in the definition of the remote control server 104.

The remote control server 104 receives an API request of S1402 from the repairing part notification server 101 via the external I/F 346, and the remote control unit 342 refers to information of the printer information managing unit 343. The remote control server 104 determines whether remote control designated by the API request is possible with reference to printer information matching a device ID designated by the API request. For example, when firmware is updated, the determination is performed with reference to a flag indicating whether firmware update is permitted in printer information. The remote control server 104 returns the result of reference to the repairing part notification server 101 via the external I/F 346.

In S1403, the repairing part estimating unit 314 receives an API response from the remote control server 104 via the external I/F 318 and determines whether remote control is possible with reference to response information. Here, for example, flag information indicating whether remote control is possible is included in the API response returned to the remote control server 104, and the repairing part estimating unit 314 determines whether an action is remotely executable with reference to a value of the flag information. A result to a response to an inquiry in S1402 returned from the remote control server 104 is not limited to flag information indicating whether remote control is possible, and a configuration in which the determination is determined using other values may be employed. When it is determined that remote control is not possible, the process of S1404 is performed. On the other hand, when it is determined that remote control is possible, the process of S1405 is performed.

In S1404, the repairing part estimating unit 314 instructs the estimation result managing unit 316 to change the remote execution in the estimation result to be impossible (FALSE). In S1405, the repairing part estimating unit 314 determines whether the remote control server 104 is inquired about all the remotely executable actions. When all the remotely executable actions are executed, the process of S412 of FIG. 4 is performed. On the other hand, when a remotely executable action to be processed remains, the process of S1401 is performed again. The third embodiment and the second embodiment may be combined. In this case, the processes according to the second embodiment (S1101 to S1104) are added between S421 and S425 in FIG. 14.

As described above, according to this embodiment, in a case in which whether remote control is possible is changed according to a setting situation in the printer 102, it is possible to determine whether remote execution is possible in consideration of settings of the printer 102 by inquiring of the remote control server 104. Accordingly, it is possible to ascertain whether the printer 102 accepts a remote operation and to provide data indicating whether remote execution is recommended.

### Other Embodiments

Embodiments of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiments and/or that includes one or more circuits (e.g., application specific integrated circuit (ASIC)) for performing the functions of one or more of the above-described embodiments, and by a method performed by the computer of the system or apparatus by, for example, reading out and executing the computer executable instructions from the storage medium to perform the functions of one or more of the above-described embodiments and/or controlling the one or more circuits to perform the functions of one or more of the above-described embodiments. The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2023-107293, filed Jun. 29, 2023, which is hereby incorporated by reference herein in its entirety.

What is claimed is:

1. An information provision system that provides information of an action recommended to resolve an error occurring in a network device, the information provision system comprising:
a memory storing instructions; and
a processor executing the instructions causing the information provision system to:
estimate an action to be executed for the error occurring in the network device;
determine whether the estimated action to be executed for the error occurring in the network device is a remotely executable action that is able to be performed by remotely transmitting a command to a target network device via a network; and
provide data for outputting information of candidates estimated as the action to be executed for the error occurring in the network device,
wherein, when the remotely executable action is included in the candidates, data for outputting information indicating that a remote job is recommended is included in the provided data.

2. The information provision system according to claim 1, wherein the data for outputting information indicating that the remote job is recommended is data for outputting one or both of a message for recommending remote execution and a message of recommending remote execution of a target action.

3. The information provision system according to claim 1, wherein information of the estimated candidates is output by a web browser based on the data.

4. The information provision system according to claim 1, wherein the processor determines whether the estimated action to be executed for the error occurring in the network device is a remotely executable action based on remote action information indicating whether each action is remotely executable.

5. The information provision system according to claim 4, wherein the processor ascertains whether the action determined to be a remotely executable action based on the remote action information is remotely received by the network device and determines whether the action is a remotely executable action.

6. The information provision system according to claim 1, wherein, when a remotely executable action is included as the candidates and a probability of a reason of the estimated error corresponding to the remotely executable action is equal to or greater than a threshold value, data for outputting information indicating that a remote job is recommended is included in the provided data.

7. The information provision system according to claim 1, wherein, when a plurality of actions are recommended to resolve one error, a sequence in which the plurality of actions including a remotely executable action are executed is not determined, and an action to be first executed out of the plurality of actions is the remotely executable action, data for outputting information indicating that a remote job is recommended is included in the provided data.

8. The information provision system according to claim 1, wherein the action which is not remotely executable is an action to be executed by operating the network device in an installation site of the network device.

9. A method of controlling an information provision system that provides information of an action recommended to resolve an error occurring in a network device, the method comprising:
estimating an action to be executed for the error occurring in the network device;
determining whether the estimated action to be executed for the error occurring in the network device is a remotely executable action that is able to be performed by remotely transmitting a command to a target network device via a network; and
providing data for outputting information of candidates estimated as the action to be executed for the error occurring in the network device,
wherein, when the remotely executable action is included in the candidates, data for outputting information indicating that a remote job is recommended is included in the provided data.

10. A non-transitory computer-readable storage medium storing a control program causing a computer to execute a method of controlling an information provision system that provides information of an action recommended to resolve an error occurring in a network device, the method comprising:
estimating an action to be executed for the error occurring in the network device;
determining whether the estimated action to be executed for the error occurring in the network device is a remotely executable action that is able to be performed by remotely transmitting a command to a target network device via a network; and
providing data for outputting information of candidates estimated as the action to be executed for the error occurring in the network device,
wherein, when the remotely executable action is included in the candidates, data for outputting information indicating that a remote job is recommended is included in the provided data.
